(19) United States
(12) Patent Application Publication
(10) Pub. No.: US 2008/0050679 A1
(43) Pub. Date: Feb. 28, 2008

(54) METHODS AND SYSTEMS FOR PERFORMING IMMERSION PROCESSING DURING LITHOGRAPHY

(75) Inventors: Mohsen S. Salek, Saratoga, CA (US); Tetsuya Ishikawa, Saratoga, CA (US); Christoper Laurent Beaudry, San Jose, CA (US); Steven Verhaverbeke, San Francisco, CA (US); Helen R. Armer, Cupertino, CA (US); Harald Herchen, Los Altos, CA (US); Leon Volfovsky, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SOKUDO CO., LTD., Kyoto (JP)

(21) Appl. No.: 11/678,034

(22) Filed: Feb. 22, 2007

Related U.S. Application Data
(60) Provisional application No. 60/776,079, filed on Feb. 22, 2006.

(51) Int. Cl. G03C 5/29; G03B 27/58

(52) U.S. Cl. 430/327; 355/72

(57) ABSTRACT

A method of processing a substrate includes forming a coating layer over a front surface of the substrate and exposing the coating layer in an immersion scanner. The coating layer may include a photoresist layer. The method also includes performing one or more immersion processes on the substrate after exposure. As an example, the one or more immersion processes include an immersion post-exposure bake process.

### CROSS-REFERENCES TO RELATED APPLICATIONS

The present application claims benefit under 35 U.S.C. § 119(e) of U.S. Provisional Patent Application No. 60/776,079, filed Feb. 22, 2006, entitled “Immersion Processing on a Track Lithography Tool,” which is incorporated herein by reference in its entirety.

### BACKGROUND OF THE INVENTION

The present invention relates generally to the field of substrate processing equipment. More particularly, the present invention relates to a method and apparatus for performing immersion processing during photolithography operations. Merely by way of example, the invention has been applied to immersion post-exposure bake and immersion develop processes performed in a track lithography tool. However, the present invention has broader applicability and can be applied to other processes for semiconductor substrates, for example those used in the formation of integrated circuits.

Modern integrated circuits contain millions of individual elements that are formed by patterning the materials, such as silicon, metal and/or dielectric layers, that make up the integrated circuit to sizes that are small fractions of a micrometer. The technique used throughout the industry for forming such patterns is photolithography. A typical photolithography process sequence generally includes depositing one or more uniform photoresist (resist) layers on the surface of a substrate, drying and curing the deposited layers, patterning the substrate by exposing the photoresist layer to electromagnetic radiation that is suitable for modifying the exposed layer, and then developing the patterned photoresist layer.

It is common in the semiconductor industry for many of the steps associated with the photolithography process to be performed in a multi-chamber processing system (e.g., a cluster tool) that has the capability to sequentially process semiconductor wafers in a controlled manner. One example of a cluster tool that is used to deposit (i.e., coat) and develop a photoresist material is commonly referred to as a track lithography tool.

Track lithography tools typically include a mainframe that houses multiple chambers (which are sometimes referred to herein as stations or modules) dedicated to performing the various tasks associated with pre- and post-lithography processing. There are typically both wet and dry processing chambers within track lithography tools. Wet chambers include coat and/or develop bowls, while dry chambers include thermal control units that house bake and/or chill plates. Track lithography tools also frequently include one or more pod/cassette mounting devices, such as an industry standard FOUP (front opening unified pod), to receive substrates from and return substrates to the clean room, multiple substrate transfer robots to transfer substrates between the various chambers/stations of the track tool and an interface that allows the tool to be operatively coupled to a lithography exposure tool in order to transfer substrates into the exposure tool and receive substrates from the exposure tool after the substrates are processed within the exposure tool.

FIG. 1 is a simplified process flow for a conventional track lithography tool. In this flow, the wafers are processed singly and are not immersed for any processes following the exposure step. Thus, the last three illustrated processes are dry processes following a dry exposure process.

Immersion lithography techniques are currently being developed. In immersion lithography, a liquid layer is positioned between the lens and the wafer surface during exposure. The index of refraction of the liquid layer reduces the minimum line width achievable during the exposure process. However, researchers have found that water droplets which remain on the wafer after exposure cause defects in the developed wafer.

FIG. 2 is a micrograph of a bridge defect resulting from an immersion lithography process. The defect shown in FIG. 2 was produced during an experiment in which some water mist was placed on a wafer to simulate immersion exposure. In the experiment, the top coat used during the lithography process was hydrophobic. The experiment for which results are illustrated in FIG. 2 simulates immersion lithography processes in which the wafer is curtain dried as the wafer leaves the scanner, with some residual water left on the wafer surface. Since the DI water used during the immersion process is recirculated a number of time in the area between the lens and the wafer, some dissolved materials, possibly leeched out of the resist, may be present in the water. As shown in FIG. 2, a bridge defect was formed between adjacent features.

Thus, there is a need in the art for methods and systems to reduce the potential for wafer defects resulting from immersion lithography processing.

### SUMMARY OF THE INVENTION

According to an embodiment of the present invention, a method of processing a substrate is provided. The method includes forming a coating layer over a front surface of the substrate and exposing the coating layer in an immersion scanner. The method also includes performing one or more immersion processes on the substrate after exposure.

According to another embodiment of the present invention, a method of processing a substrate is provided. The method includes forming one or more coating layers on a first surface of the substrate and exposing the one or more coating layers to electromagnetic radiation using an immersion scanner. The method also includes drying the substrate using a Marangoni dry technique and heating the substrate to perform a post-exposure bake process.

According to a particular embodiment of the present invention, a method of processing substrates in a track lithography tool including a plurality of linked chambers is provided. The method includes forming one or more coating layers on a front surface of the substrate in a first linked chamber of the track lithography tool and exposing a portion of the one or more coating layers using a scanner. The method also includes processing the substrate in a non-horizontal orientation in a second linked chamber of the track lithography tool.

According to another particular embodiment of the present invention, a track lithography tool for processing a substrate is provided. The track lithography tool includes a first process chamber adapted to process the substrate in a substantially horizontal orientation and a scanner interface adapted to transfer the substrate to and from a scanner. The track lithography tool also includes a second process chamber linked to the scanner interface and adapted to process the substrate in a substantially vertical orientation and a robot linked to the second process chamber and adapted to modify the orientation of the substrate to the substantially vertical orientation.

According to another embodiment of the present invention, a method of processing a substrate is provided. The method includes forming a coating layer over a front surface of the substrate, exposing the coating layer in an immersion scanner or dry scanner, and then performing one or more immersion processes on the substrate. The one or more immersion processes may include an immersion post-exposure bake process in which the substrate is heated to a predetermined temperature or an immersion develop process in which at least a portion of the coating layer is developed. For example, the immersion post-exposure bake process may utilize an immersion tank in which the substrate is processed in a substantially vertical orientation. Systems to implement these methods are also included within the scope of embodiments of the present invention.

According to an alternative embodiment of the present invention, a method of processing a substrate is provided. The method includes forming one or more coating layers on a first surface of the substrate, exposing the one or more coating layers using an immersion scanner, drying the substrate using a Marangoni dry technique, and heating the substrate to perform a post-exposure bake process. In a particular embodiment, the Marangoni dry technique includes suspended a substrate in a rinsing fluid, providing a drying vapor, and replacing said rinsing fluid with said drying vapor by directly displacing said rinsing fluid from said surfaces with said vapor at such a rate that substantially no liquid droplets are left on the surfaces after replacement of the rinsing fluid with drying vapor.

According to a specific embodiment of the present invention, a method of processing substrates in a track lithography tool including a plurality of linked chambers is provided. The method includes forming one or more coating layers on a front surface of the substrate in a first linked chamber of the track lithography tool, exposing a portion of the one or more coating layers using a scanner, and processing the substrate in a non-horizontal orientation in a second linked chamber of the track lithography tool. In a particular embodiment, the non-horizontal orientation is substantially vertical, for example within +/−5° of vertical. As an example, processing the substrate in a non-horizontal orientation is performed after exposing a portion of the one or more coating layers.

According to another alternative embodiment of the present invention, a track lithography tool for processing a substrate is provided. The track lithography tool includes a first process chamber adapted to process the substrate in a substantially horizontal orientation and a scanner linked to the first process chamber. The track lithography tool also includes a second process chamber linked to the scanner and adapted to process the substrate in a substantially vertical orientation and a robot linked to the second process chamber and adapted to modify the orientation of the substrate to the substantially vertical orientation. The robot is adapted to handle wet substrates in some embodiments.

Many benefits are achieved by way of the present invention over conventional techniques. For example, embodiments of the present invention provide methods and systems that increase track lithography tool system throughput when linked to an immersion scanner. Moreover, increases in wafer-to-wafer uniformity as well as within-wafer uniformity are achieved utilizing embodiments of the present invention. Depending upon the embodiment, one or more of these benefits, as well as other benefits, may be achieved. These and other benefits will be described in more detail throughout the present specification and more particularly below in conjunction with the following drawings.

### BRIEF DESCRIPTION OF THE DRAWINGS

FIG. 1 is a simplified process flow for a conventional track lithography tool;

FIG. 2 is a micrograph of a bridge defect resulting from an immersion lithography process;

FIG. 3A is a simplified schematic illustration of a CMP Reflexion tool with a Dessica cleaner/dryer;

FIGS. 3B-3G are simplified schematic illustrations of track lithography tools;

FIG. 4 is a simplified process flow using a cleaner/dryer according to an embodiment of the present invention;

FIG. 5 is a simplified process flow using immersion single wafer processing after immersion exposure according to an embodiment of the present invention;

FIG. 6 is a simplified process flow using immersion batch wafer processing after immersion exposure according to an embodiment of the present invention;

FIG. 7 is a simplified process flow using immersion wafer processing incorporating immersion OCD according to an embodiment of the present invention;

FIG. 8 is a simplified process flow for single wafer processing using a drying process after immersion exposure according to an embodiment of the present invention;

FIG. 9 is a simplified process flow for batch wafer processing using a drying process after immersion exposure according to an embodiment of the present invention;

FIG. 10 is a simplified process flow incorporating backside cleaning prior to exposure according to an embodiment of the present invention;

FIG. 11 is a simplified process flow incorporating backside cleaning after exposure according to an embodiment of the present invention; and

FIG. 12 is a simplified cross-sectional view of a boundary layer control plate according to an embodiment of the present invention.

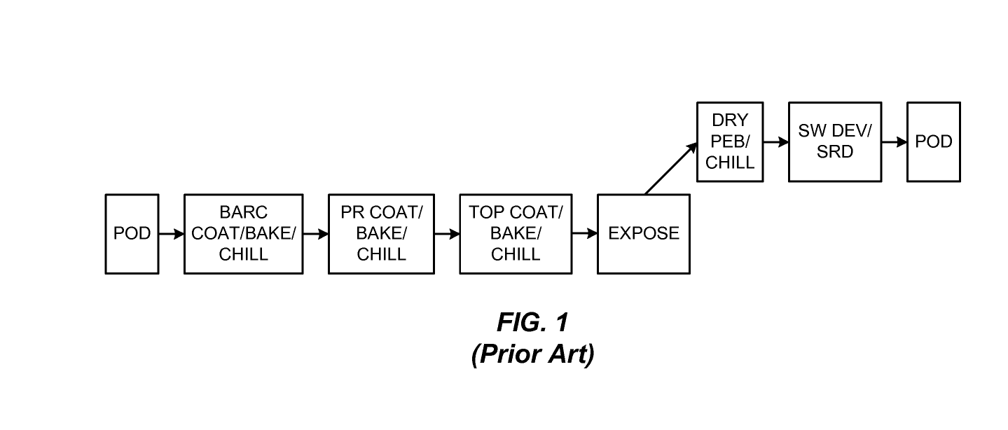

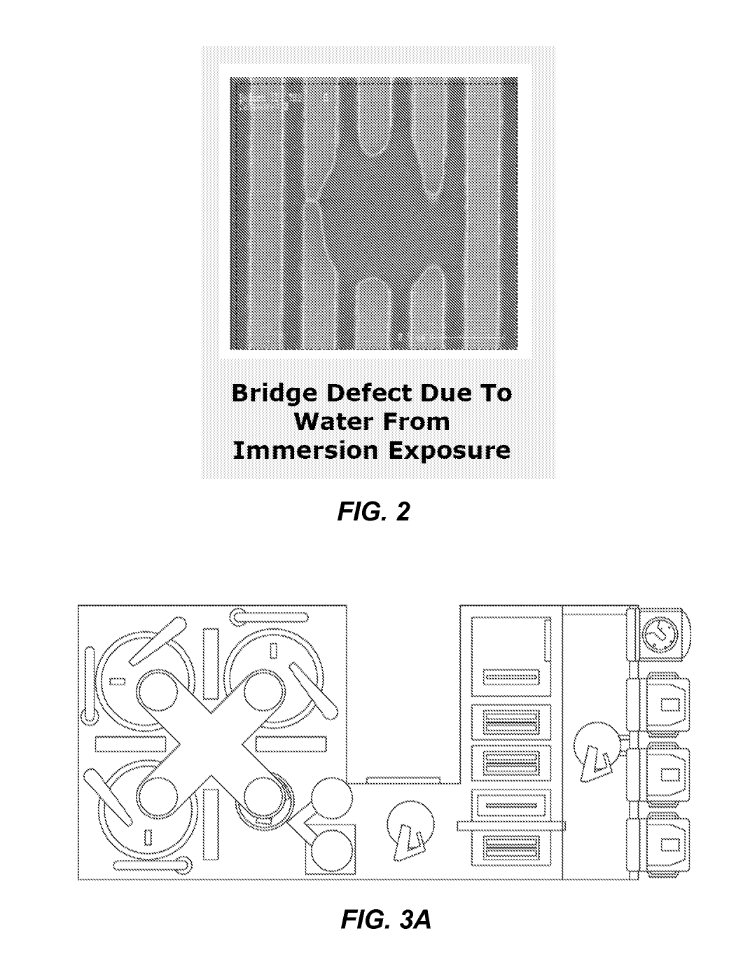

### DETAILED DESCRIPTION OF SPECIFIC EMBODIMENTS

According to the present invention, techniques related to the field of substrate processing equipment are provided. More particularly, the present invention relates to a method and apparatus for performing immersion processing during photolithography operations. Merely by way of example, the invention has been applied to immersion post-exposure bake and immersion develop processes performed in a track lithography tool. However, the present invention has broader applicability and can be applied to other processes for semiconductor substrates, for example those used in the formation of integrated circuits.

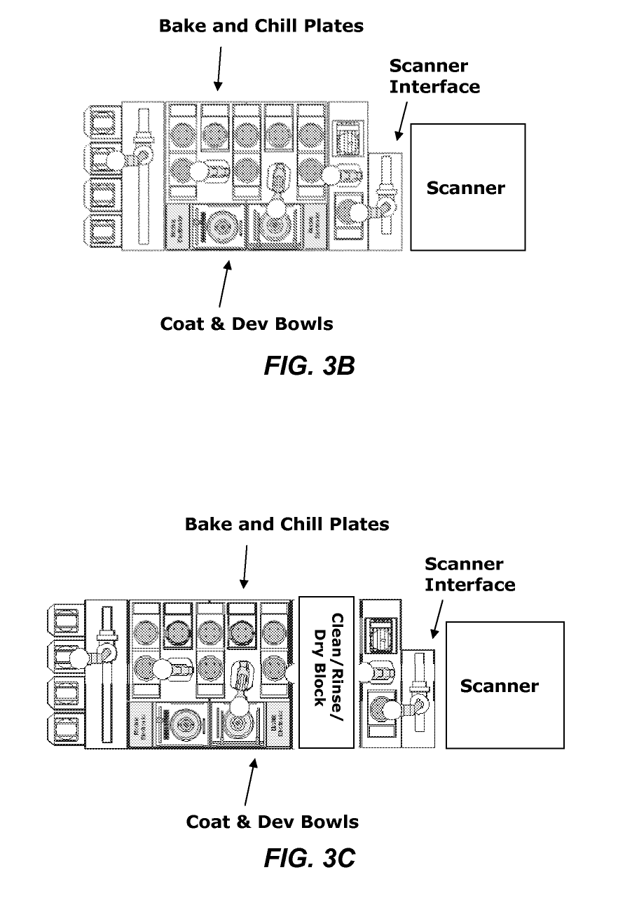

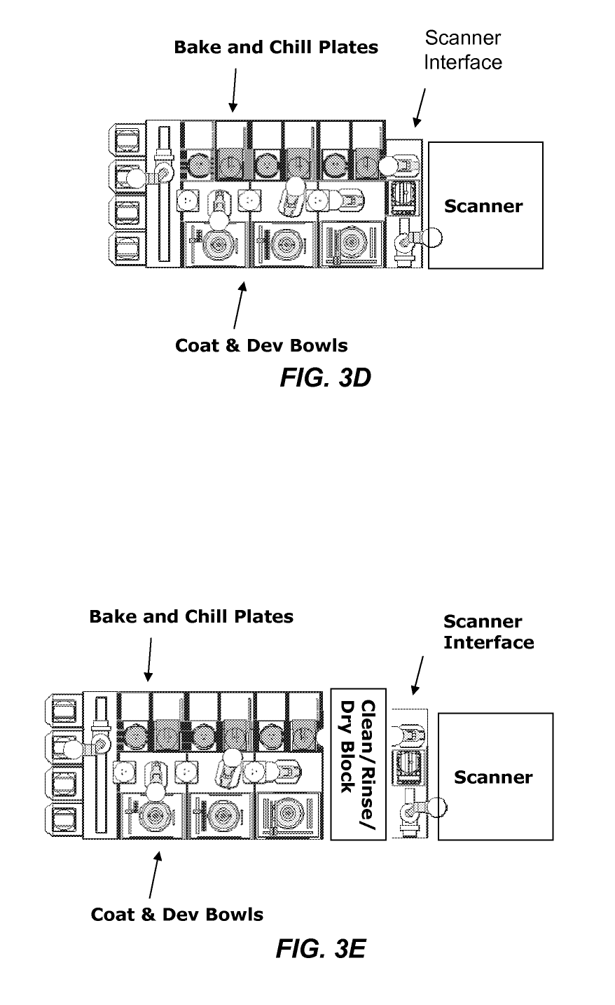

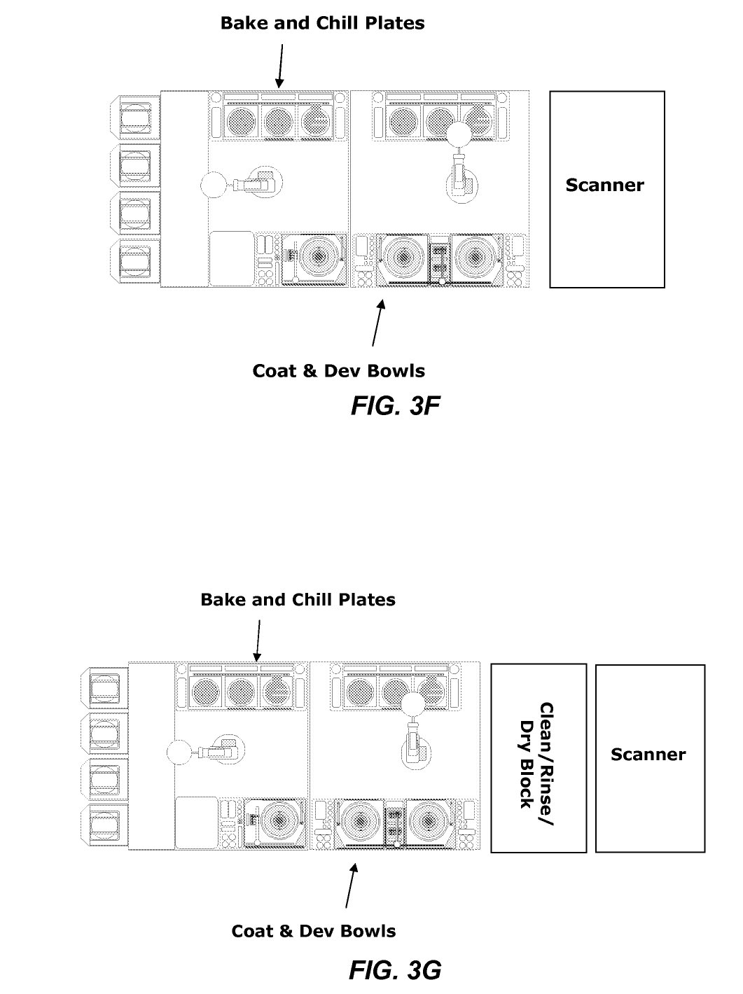

FIG. 3A is a simplified schematic illustration of a CMP Reflexion tool with a Dessica cleaner/dryer. An embodiment of the present invention incorporates technology related to cleaner/dryer systems, such as a Dessica tool, into a track lithography tool. According to embodiments of the present invention, systems that employ Marangoni dry methods and techniques, similar to a Dessica-style unit, is incorporated during the lithography processes performed using track lithography tools as provided herein. Embodiments of the present invention incorporating a post-exposure clean and dry process have been shown to reduce defects resulting from water spots produced during immersion lithography. Additionally, various “walking beam” and “running beam” wafer movement techniques, as utilized in some CMP tools, are also included according to embodiments of the present invention. As described more fully throughout the present specification, a number of semiconductor processes and apparatuses are provided by embodiments of the present invention. These processes and apparatuses include, without limitation:

Immersing the wafer in a liquid during processing on a track. This could be done for the post-exposure bake (PEB) step, the develop (DEV) step, a clean step, or for optical CD (OCD) metrology. Each of these steps may include additional sub-steps as appropriate to the particular application.

Immersion processes on a track using a single wafer flow. This refers to processing the wafers wet but one at a time, vs. processing wafers wet but in batches with batch size ≧2.

Immersion processes on a track that use batch flow (≧2 wafers per batch). This is analogous to the above, with the variation that wafers are processed in batches. Additionally, the conventional spin-rinse-dry (SRD) after DEV is replaced with a Marangoni dry in some embodiments.

Inserting a clean/rinse/dry process on the track after exposure (EXP) and before PEB. This can be done for both dry and immersion process flows and for both single wafer and batch process flows.

Inserting a wafer backside clean process on the track just prior to entering the scanner. Additionally, a wafer backside clean just after EXP is also described.

An immersion OCD step can be added after DEV on any of the immersion flows described above. “Wet OCD” as implemented on some Applied Materials CMP tools is included in specific embodiments.

The use of “walking beam” and “running beam” wafer flow management in track process modules that immerse the wafer, similar to wafer flow patterns used on Applied Material's CMP tools. As will be evident to one of skill in the art, some CMP tools have used a “wet walking beam.” Additionally, wet walking beam techniques have been used in some semiconductor polishing, cleaning, and drying equipment.

FIGS. 3B, 3D, and 3F are simplified schematic illustrations of track lithography tools. FIGS. 3C, 3E, and 3G are simplified schematic illustrations of clean/rinse/dry blocks integrated into track lithography tools according to embodiments of the present invention. Although clean/rinse/dry blocks based on the Dessica dryer are illustrated, the present invention is not limited to these particular blocks. Sub-units including one or more clean/rinse/dry modules are utilized in some embodiments.

FIG. 3B is a simplified schematic illustration of a LITHIUS™ track lithography tool (track), available from Tokyo Electron Limited of Tokyo, Japan. Conventional tracks are built in blocks. A block typically comprises coat bowls and bake/chill modules or develop bowls and bake/chill modules.

FIG. 3C is a simplified schematic illustration of a clean/rinse/dry block integrated into a LITHIUS™ track lithography tool according to an embodiment of the present invention. As illustrated in FIG. 3C, the Clean/Rinse/Dry processing is implemented into the conventional process flow by adding a clean/rinse/dry block that contains the Clean/Rinse/Dry hardware. In a particular embodiment, the clean/rinse/dry block is a dedicated block that does not contain coat, develop or bake/chill modules. As illustrated in FIG. 3C, the clean/rinse/dry block is integrated after the process bowls and before the scanner interface between the scanner and the rest of the track. Accordingly, wafers are sent from and delivered to the additional process modules provided by the clean/rinse/dry block before and after exposure. In some embodiments, pre-exposure cleaning is performed, with or without drying processes, as appropriate to the particular application.

Although not illustrated in FIG. 3C (or the other integrated designs shown in FIGS. 3E and 3G), other architectural features are included according to embodiments of the present invention that implement additional processes. These features include flipping the wafer from a horizontal to a vertical position after exiting the scanner and using robots that are capable of handling wet wafers and being immersed.

In an embodiment, handling wafers horizontally and handling wafers vertically is included in embodiments of the present invention. Accordingly, one or more flexible robots are provided. For example, a master robot and one or more slave robots are used in an embodiment. Although conventional track lithography tools with linked units, similar to those illustrated in FIGS. 3B-3G process wafers in horizontal orientations, processing of wafers in non-horizontal orientations is provided by embodiments of the present invention. In particular, embodiments of the present invention use one or more robots to place a substrate in a substantially vertical orientation (e.g., within +/−5° from vertical) in order to perform immersion processing. In other embodiments, the angles are farther from vertical, for example, +/−20° or more. The non-horizontal processing is applicable prior to exposure, after exposure, or both.

FIG. 3D is a simplified schematic illustration of an RF³ track lithography tool, available from Sokudo Co., Ltd, of Kyoto, Japan. FIG. 3E is a simplified schematic illustration of a clean/rinse/dry block integrated into an RF³ track lithography tool according to an embodiment of the present invention. As illustrated in FIG. 3E, the clean/rinse/dry block is integrated after the process bowls and before the scanner interface. Accordingly, wafers are sent from and delivered to the additional process modules provided by the clean/rinse/dry block before and after exposure. In some embodiments, pre-exposure cleaning is performed, with or without drying processes, as appropriate to the particular application.

FIG. 3F is a simplified schematic illustration of a track lithography tool designed by Sokudo Co., Ltd, of Kyoto, Japan. Additional description of this track lithography tool is provided in U.S. patent application Ser. No. 11/112,281, entitled “Cluster Tool Architecture for Processing a Substrate” filed on Apr. 22, 2005, which is hereby incorporated by reference for all purposes and including configurations not described in the above referenced application. FIG. 3G is a simplified schematic illustration of a clean/rinse/dry block integrated into the track lithography tool illustrated in FIG. 3F according to an embodiment of the present invention.

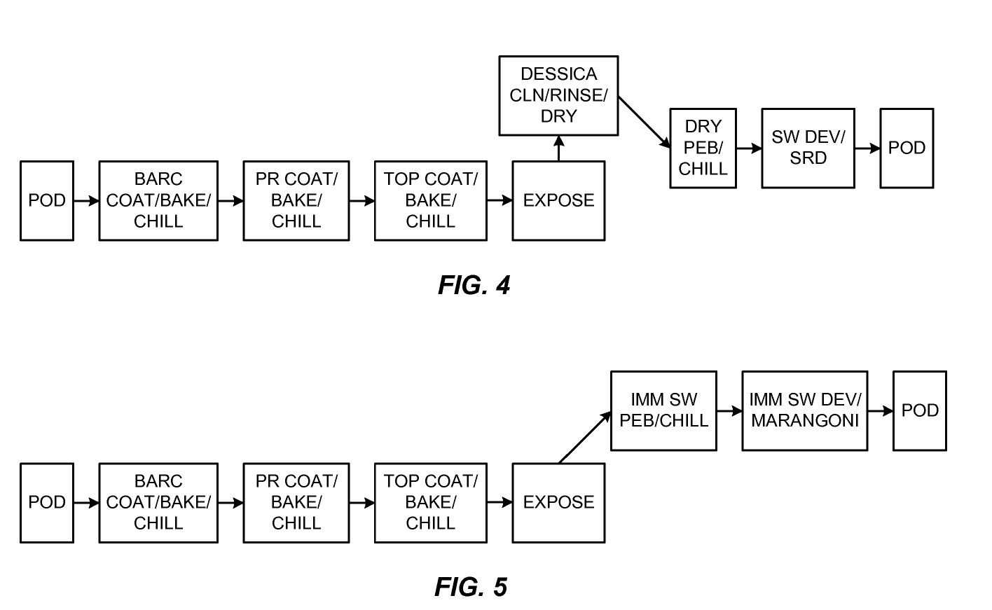

FIG. 4 is a simplified process flow using a cleaner/dryer according to an embodiment of the present invention. As illustrated in FIG. 4, a single wafer track process flow is utilized with a Clean/Rinse/Dry step inserted after immersion exposure. In the illustrated embodiment, the wafer is cleaned and dried after an immersion exposure step, thereby removing all or most of the defects resulting from immersion. The cleaner/dryer is integrated into the track lithography tool in an embodiment. After the clean/rinse/dry process, the processing continues using conventional PEB and develop processes. As illustrated in FIGS. 3C, 3E, and 3G, the implementation of clean/rinse/dry processes after immersion exposure may be performed for several track lithography tool architectures. As discussed below in relation to Marangoni drying techniques, watermark free drying techniques utilized after immersion lithography may be used to prevent watermark defects that adversely impact device performance.

Wafers are processed singly and the use of the Dessica enables a process flow in which conventional non-immersion single wafer processes are utilized. Although a Dessica system is utilized in the embodiment illustrated in FIG. 4, this is not required by the present invention. Alternative cleaner/dryer/rinse systems are utilized in alternative embodiments. A variety of robots may be utilized to move the wafer from the scanner, to the cleaner/dryer unit and then to the PEB bake/chill module. Generally, when the wafer comes out of the scanner, the wafer is dry enough for dry robot handling. In some embodiments, the robot is a 6-axis robot interfacing the cleaner/dryer to the scanner. One of ordinary skill in the art would recognize many variations, modifications, and alternatives.

An alternative approach to dry post-exposure processing, as illustrated in FIG. 4, is provided by embodiments of the present invention. Current processes have CD uniformity requirements of about 5% of the line width that is targeted by the process. Thus, for example, for a 45 nm process, the CD is preferably about +/−2 nm. Because most photoresists have a sensitivity of about 5-10 nm/° C., the temperature uniformity of the wafer during the post exposure bake (PEB) process is preferably +/−0.1° C. Utilizing a conventional hot plate, achieving this temperature uniformity target is difficult. Not only is the temperature uniformity of the hot plate an issue, the transfer of the wafer onto the hot plate may introduce temperature non-uniformities that will impact the CD uniformity. A further complication is the wafer bowing, particularly in product wafers, that results in a variation in the separation distance between the wafer and hot plate as a function of position. Accordingly, embodiments of the present invention utilize immersion-style post-exposure processing to achieve the desired temperature uniformity across the wafer.

Table 1 lists CD uniformity requirements as defined by the TTRS Roadmap. As shown in the table, the CD control targets are decreasing over time.

TABLE 1
CD Uniformity Requirements.
ITRS Roadmap CD Control Targets

| | | | | |
|---|---|---|---|---|
| CD Control, nm (3σ) | 2004 | 2006 | 2008 | 2010 |
| MPU Gate | 3.3 | 2.5 | 2.0 | 1.6 |

In order to meet these CD uniformity requirements, the inventors have determined that the temperature uniformity specification within the wafer is ±0.1° C. Accordingly, embodiments of the present invention provide the desired temperature uniformity across the wafer during the immersion PEB process.

In a conventional bake process, the wafer is placed in the bake chamber, typically on lift pins, and thermal transfer mechanisms, dominated by air transport mechanisms, are used to heat the wafer surface. In contrast, embodiments of the present invention utilizing liquid post-exposure processes are characterized by rapid conduction processes in comparison to dry processes. As a result, increases in wafer-to-wafer uniformity and within-wafer uniformity are achieved. Several approaches are utilized to achieve the desired wafer temperature uniformity, including tilting the wafer during entry into the bath, with the wafer placed in the bath at an angle. In an embodiment, the wafer is rotated during entry or exit, or both, in order to reduce edge-to-edge non-uniformities or center-to-edge non-uniformities and to “even out” the temperature distribution. Rotation may be applied to either tilted or vertical wafers. Additionally, improved uniformity control is provided by a rotational input during processing. One of ordinary skill in the art would recognize many variations, modifications, and alternatives.

In a particular embodiment, the wafer is removed from the bath at an orientation rotated 180° from the entry orientation to reduce non-uniformities. A surfactinated rinse may be used in between exposure and PEB. Such a surfactinated rinse could help remove particles present on the surface of the photoresist.

Embodiments of the present invention are not limited to inserting and removing a wafer at a single position. In some systems provided according to embodiments of the present invention, the wafer may be moved from an entry location to an exit location by a number of walking beams or other transport mechanism. Processing of the wafer is performed as the wafers are moved through the system by the walking beams or other transport mechanism. Thus, the wafer drop off or entry location may be different than the pick up or exit location. Both walking and running beams, similar to those used in CMP systems, are included according to embodiments of the present invention.

In an embodiment, after immersion PEB (for example, in an oil), the wafer is moved to a room temperature bath to cool the wafer down and then to a developer bath for an immersion develop process or to a develop bowl as appropriate to the particular develop process utilized. The chill step following immersion PEB is generally performed in a fluid with a boiling point greater than the temperature of the PEB process. As a result, the chill step may utilize the same fluid used for the immersion PEB, but at a lower temperature than the PEB temperature. In some process flows, the wafer is cleaned after the PEB and chill steps to remove the immersion PEB and chill fluid from the wafer prior to the develop process. A heater or chiller (e.g., Peltier chiller) can be used to maintain the PEB and chill baths at appropriate temperatures. One of ordinary skill in the art would recognize many variations, modifications, and alternatives.

After develop, the wafer is moved to a rinse bath followed by a dry step. An additional dry step could also be performed prior to the develop step. Preferably the system is configurable, enabling processing that proceeds along one of several predetermined process flows. Thus, a number of interchangeable modules are envisioned by the present inventors.

During PEB on a hot plate, solvent and by-products of cross-linking evolve and are carried away by the exhaust flow in the bake chamber. Similarly, during DEV, photoresist is removed from the wafer by dissolving in the developer solution. In embodiments of the present invention in which immersion PEB and DEV are implemented, methods are provided for transporting the evolved species, dissolved species, and reaction by-products away from the wafer. Accordingly, in both PEB and develop processes, process byproducts are removed from the wafer surface. These byproducts include gases evolving from the surface, liquids, and the like. A variety of mechanisms for byproduct removal are provided herein, including motion in the bath, vibration of the wafer, spinning or rotating of the wafer, chemical reactions, and the like. Additionally, agitating the liquid in the PEB or DEV process may be induced by (a) injecting a gas to create bubbles, (b) spinning a rotor, or (c) using megasonics, among other methods. As will be evident to one of skill in the art, agitation may be more aggressive during PEB, in which the pattern is not yet formed, than for DEV, in which a pattern is forming. Moreover, inducing liquid flow to create liquid phase convection to carry away “spent” liquid and replace it with “fresh” liquid is performed by (a) implementing liquid level overflow (e.g., a wier, in which spent liquid will spill over into a drained tank and be replaced with fresh liquid), and using a Dessica-type isolation, described more fully below, among other methods.

In an embodiment, solid byproducts rise to the surface of the liquid in the process tank. A surface divider is used to separate the floating solid byproducts from the wafer exit location. Thus, in a Dessica design, the wafer goes in on one side of a surface divider and exits on the other side of the surface divider, with the process byproducts contained on the entry side.

There are several approaches to providing for removal of process byproducts from the wafer surface. Most of these approaches serve to maintain a non-zero liquid velocity in the vicinity of the boundary layer at the wafer surface. As process byproducts diffuse across the boundary layer, they are transported away from the wafer surface by the velocity of the liquid outside the boundary layer. Thus, embodiments of the present invention reduce or prevent the process byproducts from concentrating near the surface of the wafer. As will be evident to one of skill in the art, such byproduct concentration may result in slowing down or choking off the PEB, develop, and/or cleaning processes. Moreover, in some embodiments, clean/rinse/dry processes implemented on a track are the same as stand-alone clean/rinse/dry processes. For these processes, clean byproducts are generally removed by inducing cavitation.

Motion of the wafer or motion of the liquid in which the wafer is immersed may be accomplished in several manners. For example, the application of low levels of megasonic energy to the bath will result in mixing of the liquid in the bath, without agitation of particles near the wafer surface, which may serve to damage the resist or patterns formed in the resist. For PEB processes, with no pattern formed in the resist, and therefore less likelihood of scouring by particles present in the liquid, the level of megasonic energy may be higher than that used for develop processes, in which patters are present in the resist. Thus, for PEB processes, only liquid mixing is provided, whereas in develop processes, gentle cleaning and liquid mixing are provided. Spinning or rotating the wafer may also provide a velocity differential, tending to carry away process byproducts. Additionally, the use of additives in the liquid may enhance these processes.

Thus, forcing the flow of the liquid past the boundary layer near the surface of the wafer is utilized, in conjunction with convection to remove process byproducts. As discussed above, the differential flow is relevant, not necessarily the particular motion of either the wafer or the liquid. Gas injection or other forms of agitation may be used to provide local variations in the liquid density. Air jets may be used to provide this gas injection or agitation.

Conventional track processes (coating, develop, rinse/dry) use spinning during the process. Generally, spinning flattens the boundary layer and provides a uniform thickness boundary layer across the wafer. A thin and uniform boundary layer is thought to be preferable for at least two reasons: (1) in processes that apply material, such as coating, a think and uniform boundary layer facilitates uniform deposition, and (2) in processes that remove material, such as develop, clean and/or rinse/dry, a thin and uniform boundary layer facilitates transport of the removed material away from the wafer surface, thus creating a concentration gradient for continued removal.

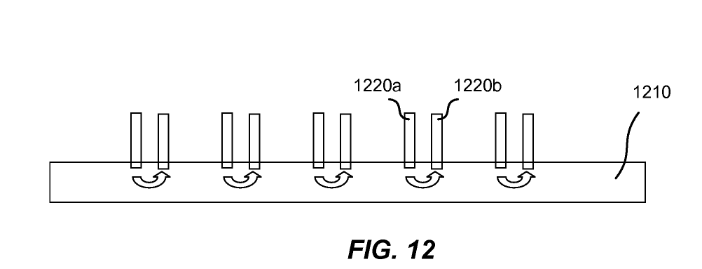

An alternative to spinning of the wafer is to use a boundary layer control technique utilizing a series of small holes in a plate to deliver and remove small volumes of material. FIG. 12 is a simplified cross-sectional view of a boundary layer control plate according to an embodiment of the present invention. Accordingly, the concept illustrated in FIG. 12 is used in embodiments of the present invention during immersion processes described throughout the present specification. For example, the techniques discussed in relation to FIG. 12 are applicable to both develop and rinse processes.

As illustrated in FIG. 12, a boundary layer 1210 is formed on the surface of the substrate (not shown). In some applications with liquid/solid interfaces, the thickness of the boundary layer is about 200 μm. A boundary layer of 200 μm may result in undesirable byproduct concentration. To reduce these boundary layer effects, a mechanical plate with holes 1220 is positioned at a predetermined distance from the upper surface of the substrate. In a particular embodiment, the predetermined distance is about 20 μm. In alternative embodiments, the predetermined distance ranges from about 5 μm to about 50 μm. A liquid is pumped into a first set of orifices 1220a and removed through a second set of orifices 1220b corresponding to the first set of orifices. Accordingly, the boundary layer effects in the boundary layer 1210 are reduced, increasing motion of the reaction byproducts at the substrate surface. Thus, embodiments of the present invention provide tank processing solutions with boundary effects reduced to levels comparable to spinning processes.

Some 193 nm DUV processes use coatings on top of the photoresist. The two coatings currently applied over photoresist are TARC (top anti-reflective coating) and Top Coat (a film used in immersion lithography that protects the scanner lens from attack by the photoresist). In most cases, TARC and Top Coat are removed along with exposed photoresist in the DEV step. However, their composition differs from photoresist. In an embodiment of the present invention, these coatings are removed separately using different solvents. These different solvents are then separated in the DEV drain from the developer solvents. One way to accomplish this separate is to create zones along a vertical axis. One zone will apply solvent used to remove TARC/Top Coat. A second zone will apply the developer solvent. The wafer is moved up through the zones and wiers are inserted to direct the solvent flow to separate drains.

Alternatively, if conventional bowl-type develop hardware is used, separation can be accomplished by nesting bowls or nesting drains. Another alternative is to move the bowl up through zones like those described above. One of ordinary skill in the art would recognize many variations, modifications, and alternatives.

Therefore, according to embodiments of the present invention, because a cleaning capability is provided after exposure, a process includes forming the top coat on the photoresist to seal the photoresist from attack by water, cleaning either the topside or backside of the wafer or both, exposing the wafer, and cleaning the wafer after exposure. Depending on the particular process, the wafer may be dried after the cleaning step.

In an embodiment, top coat removal is performed in a single module including develop, rinse, and dry portions in the single module. For example, develop could be performed in a lower portion of the stage, rinse in an intermediate portion, and dry in an upper portion. Accordingly recycling of process fluid is implemented in this design. The motion of the cup may be implemented to translate the wafer in the vertical direction.

FIG. 5 is a simplified process flow using immersion single wafer (SW) processing after exposure according to an embodiment of the present invention. As illustrated in FIG. 5, wafers are processed singly and are immersed for PEB and develop (DEV) processes after exposure. In an embodiment, the immersion chamber is a tank.

The PEB process takes place at temperatures in the range of about 90° C. to about 140° C. Some applications utilize higher PEB temperatures up to about 200° C. In a particular embodiment, the PEB temperatures ranges from about 120° C. to about 125° C. Hence, in this particular embodiment, a liquid with an atmospheric pressure boiling point above the PEB temperature, for example, above 125° C. is utilized. Examples of suitable liquids include oils, ethylene glycol, and the like. Additional suitable liquids are listed in the CRC Handbook of Chemistry and Physics, 85^{th} edition, CRC Press, 2004. According to embodiments of the present invention, the liquid is selected to be compatible with the resist, top coat, TARC, BARC, or other materials present on the surface of the wafer. Compatibility is generally determined in terms of low dissolution rates of the resist in the liquid. Generally acidic liquids are not utilized, as they can have a tendency to etch the wafer.

According to some embodiments of the present invention, the time utilized to perform the PEB process is reduced in comparison to conventional PEB techniques. As an example, conventional techniques include a time to ramp up the temperature of the wafer from the initial temperature after immersion exposure to the bake temperature. Here, the higher thermal conductivity of the PEB fluid (in comparison to air) achieves a ramp curve with a steeper slope than conventional techniques. As a result, the total process time is reduced by embodiments of the present invention.

Immersions processes (e.g., PEB and DEV) are carried out in an immersion tank according to embodiments of the present invention. In one embodiment, such tanks are at least twice the diameter of the wafer being processed. The lower half of the tank is filled with the processing liquid. The height of the liquid in the lower half of the tank is selected to exceed that of the wafer to ensure the wafer is fully immersed. The wafer is lowered into this liquid in an embodiment. In an embodiment, the wafer is tilted when lowered into the immersion liquid, enabling the liquid height in the lower half of the tank to be less than that of the wafer diameter.

Moreover, several immersion tanks operated at different temperatures may be used to avoid the use of set point change processes. In some conventional designs, a bake plate is used for a first bake process at a first temperatures and then the set point of the bake plate is changed to a second temperature different from the first temperature. Here, multiple immersion tanks are used to provide bake processes at different temperatures. As a result, the time used to perform the set point change is saved, increasing system throughput. In other embodiments, fluid in a single immersion tank is changed or partially changed to effect a set point change. One of ordinary skill in the art would recognize many variations, modifications, and alternatives.

When the immersion process is complete, the wafer is raised above the liquid until the wafer is completely removed from the bath. Rinsing and drying are typically performed in a separate tank that used a Marangoni dry process. Cleaning processes may also be utilized at this point in the process flow. In an alternative embodiment, the rinsing and drying are performed in the same tank utilized for the immersion PEB and DEV processing. One of ordinary skill in the art would recognize many variations, modifications, and alternatives.

The conventional spin-rinse-dry (SRD) process typically utilized after develop is replaced with a Marangoni dry process in some embodiments. Marangoni processes are described in U.S. Pat. No. 4,911,761 as well as other patents, applications, and publications. Of course, a conventional SRD may also be used according to alternative embodiments.

Marangoni dry is a technique in which object surfaces, such as semiconductor wafers, which are suspended in a rinsing fluid, may be dried by replacing the rinsing fluid, such as water, with a drying vapor by directly displacing the water from the surfaces at such a rate that substantially no liquid droplets are left on the surfaces after replacement of the water with drying vapor. In embodiments of the present invention, the drying vapor is miscible with water and forms a minimum-boiling azeotrope with water, such as isopropanol. The drying vapor is then purged with a stream of dry, inert, non-condensable gas such as nitrogen. A vaporizer with automatic refill mechanism produces saturated drying vapor which may then be flashed to a superheated vapor prior to contacting the surfaces, which preferably are at the same temperature as the vapor. Preferably, no liquid is removed by evaporation, and the drying takes place in an enclosed, hydraulically full system which does not require movement or handling of the surfaces between rinsing and drying steps.

In embodiments of the present invention, proven Marangoni vapor dry processing is used for one or more wafer drying steps. All variations of the Marangoni process, including Rotagoni, are included herein. For example, drying with IPA, the most common vapor used to displace water from the surface of the workpiece is included, as well as the use of other liquids, such as hexamethyldisiloxane (HMDS). The use of HMDS is easily integrated into dry processes because HMDS is already plumbed to track lithography tools because it is used to remove water from wafers prior to coating. Other drying chemicals can be found in the Marangoni literature.

According to an embodiment, a Marangoni dry process is utilized after immersion exposure to reduce the occurrence of watermark defects on the surface of the exposed resist. Watermark defects, which may appear on planar resist surfaces, are prevented by performing a Marangoni drying process after immersion lithography. As illustrated in FIG. 5, an immersion single wafer develop process is utilized followed by a Marangoni dry process. In this embodiment, a vapor chamber is provided above the developer bath. As the wafer is removed from the developer bath, the developer is removed from the wafer surface. Particles may be removed during the process of removing the developer fluid and drying the wafer, thereby improving device reliability.

Although FIG. 5 illustrates immersion processing after immersion lithography, embodiments of the present invention provide for immersion processing, including PEB and DEV, for non-immersion lithography systems. Thus, although dry lithography exposure is performed, immersion post-exposure processing is performed in some embodiments of the present invention.

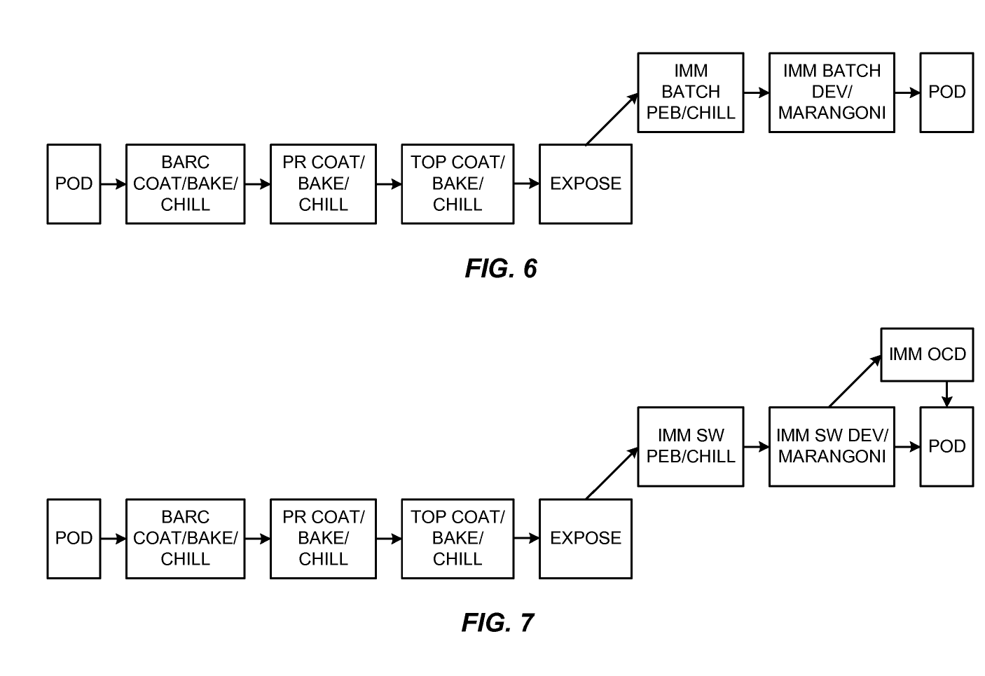

FIG. 6 is a simplified process flow using immersion batch wafer processing after exposure according to an embodiment of the present invention. In this embodiment, wafers are processed in batches and are immersed for PEB and DEV. As discussed in relation to FIG. 5, a Marangoni dry is utilized to replace the conventional SRD process. Of course, a conventional SRD may also be used according to alternative embodiments.

FIG. 7 is a simplified process flow using immersion wafer processing incorporating immersion OCD according to an embodiment of the present invention. In an embodiment, scatterometry OCD is performed in an immersion environment, reducing the diffraction limit and enhancing the resolution and accuracy of the OCD processes. Both single wafer and batch processes are included in the embodiments illustrated by FIG. 7. One of ordinary skill in the art would recognize many variations, modifications, and alternatives.

FIG. 8 is a simplified process flow for single wafer processing using a drying process after immersion exposure according to an embodiment of the present invention. As illustrated, a clean/dry/rinse process, for example, a Dessica-style process, is used after immersion exposure to produce a dry wafer. Subsequently, immersion processes are used for the PEB and DEV processes. A Marangoni dry process is utilized to dry the wafer prior to delivery to the Pod. In an alternative process, the drying process is not utilized, but the wafer is cleaned and rinsed, or only rinsed, after immersion lithography. This alternative embodiment is utilized in applications in which immersion processing is performed after immersion lithography and the wafer is maintained in a wet state during lithography and post-exposure immersion processing.

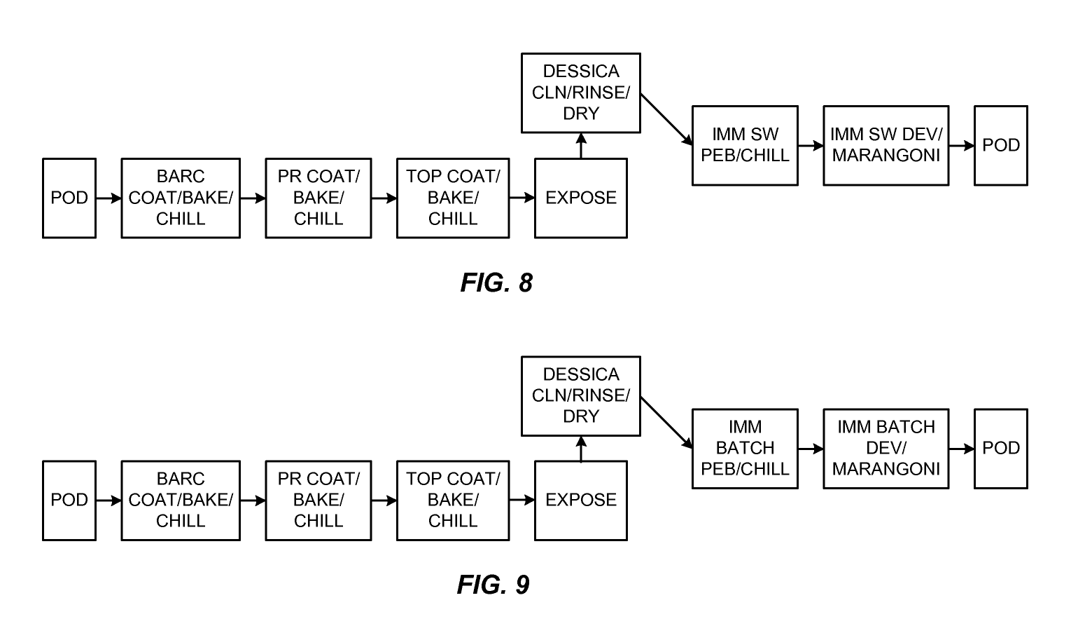

FIG. 9 is a simplified process flow for batch wafer processing using a drying process after immersion exposure according to an embodiment of the present invention. The process illustrated in FIG. 9 is similar to that illustrated in FIG. 8, however, batch processing is performed. One of ordinary skill in the art would recognize many variations, modifications, and alternatives.

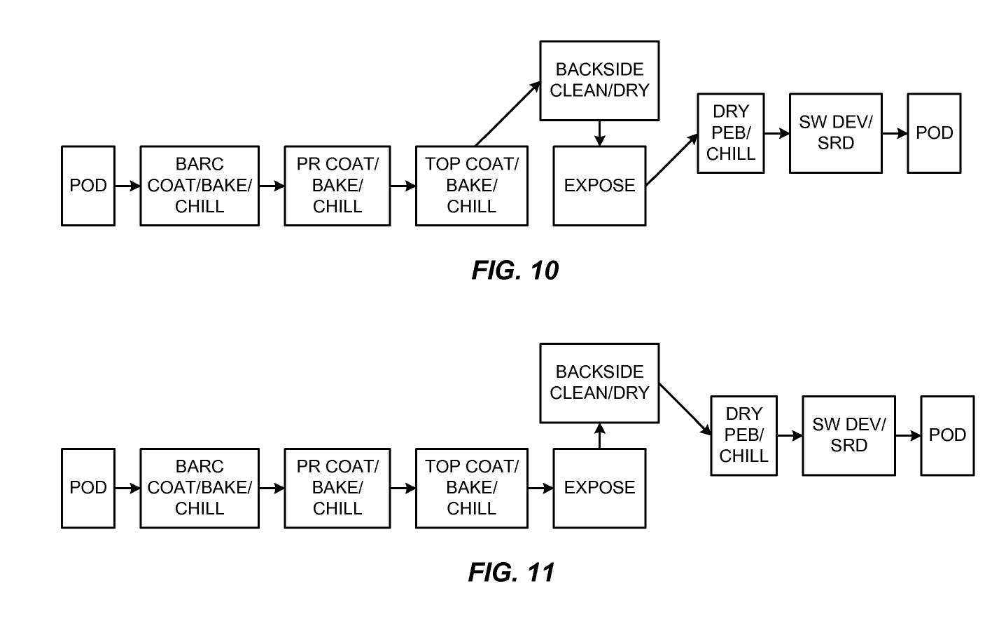

In an embodiment, the cleaning unit provided in the track lithography tool is used to clean wafers, before immersion exposure, after immersion exposure, or both. Additionally, the wafer may be cleaned after an immersion PEB process. FIG. 10 is a simplified process flow incorporating backside cleaning prior to exposure according to an embodiment of the present invention. Particularly, backside cleaning is used to remove particles from the backside of the wafer. It has been shown that if there are particles on the backside of the wafer entering the scanner, when the wafer is chucked in the scanner, it doesn't align properly, and hot spots are generated. Accordingly, it is preferable to remove backside particles from the wafer prior to entering the scanner as illustrated in FIG. 10.

FIG. 11 is a simplified process flow incorporating backside cleaning after exposure according to an embodiment of the present invention. As illustrated, backside cleaning may be performed after exposure. Because a product wafer will go through a number of lithography steps during processing, removal of particles after exposure will reduce the number of particles present at a subsequent exposure step. Accordingly, a backside clean step is utilized as the last step after the immersion exposure step in the embodiment illustrated in FIG. 11. Utilizing a Dessica-style clean and dry process, defects are removed, the wafer enters the PEB chamber dry, and dry processing is utilized for the remaining process steps. One of ordinary skill in the art would recognize many variations, modifications, and alternatives.

Embodiments of the present invention provide for environmental control for immersion processes on track lithography tools. For example, if a wafer is exposed under water in the scanner (as performed during immersion lithography), embodiments of the present invention maintain the surface of the wafer in a wet state until it goes to the next process step. This is accomplished in one of several manners, for example, by adding misters to the scanner interface or by keeping the scanner interface at a high relative humidity.

Additionally, embodiments provide for pH control during tank immersion develop processes. A number of methods of controlling pH are utilized depending on the embodiment, including adding basic materials (i.e., pH>7) to the immersion fluid. As an example, CO₂ gas is added in a specific embodiment. Moreover, embodiments utilize “super DI water” in the rinse steps after develop or after clean.

It should be appreciated that the specific steps illustrated in FIGS. 4-11 provide particular methods of performing post-exposure immersion processing according to various embodiments of the present invention. Other sequences of steps may also be performed according to alternative embodiments. For example, alternative embodiments of the present invention may perform the steps outlined above in a different order. Moreover, the individual steps illustrated in FIGS. 4-11 may include multiple sub-steps that may be performed in various sequences as appropriate to the individual step. Furthermore, additional steps may be added or removed depending on the particular applications. One of ordinary skill in the art would recognize many variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of processing a substrate, the method comprising:
forming a coating layer over a front surface of the substrate;
exposing the coating layer in an immersion scanner; and
then performing one or more immersion processes on the substrate.

2. The method of claim 1 wherein the coating layer comprises photoresist.

3. The method of claim 1 wherein the coating layer comprises at least one of a BARC, a TARC, or a top coat.

4. The method of claim 1 wherein the one or more immersion processes comprises an immersion post-exposure bake process.

5. The method of claim 4 wherein the immersion post-exposure bake process is performed at a temperature between about 90° C. and about 200° C.

6. The apparatus of claim 4 wherein the immersion post-exposure bake process is performed in an immersion tank adapted to process the substrate in a vertical orientation.

7. The method of claim 1 wherein the one or more immersion processes comprises an immersion develop process.

8. A method of processing a substrate, the method comprising:
forming one or more coating layers on a first surface of the substrate;
exposing the one or more coating layers to electromagnetic radiation using an immersion scanner;
drying the substrate using a Marangoni dry technique; and
heating the substrate to perform a post-exposure bake process.

9. The method of claim 8 wherein the Marangoni dry technique comprises:
suspended a substrate in a rinsing fluid;
providing a drying vapor;
replacing said rinsing fluid with said drying vapor by directly displacing said rinsing fluid from said surfaces with said vapor at such a rate that substantially no liquid droplets are left on the surfaces after replacement of the rinsing fluid with drying vapor.

10. The method of claim 8 wherein the Marangoni dry technique is performed after exposing the one or more coating layers.

11. The method of claim 9 wherein the rinsing fluid comprises de-ionized water.

12. The method of claim 8 wherein the coating layer comprises at least one of photoresist, a BARC, a TARC, or a top coat.

13. The method of claim 8 wherein the post-exposure bake process is performed at a temperature between about 90° C. and about 140° C.

14. A method of processing substrates in a track lithography tool including a plurality of linked chambers, the method comprising:
forming one or more coating layers on a front surface of the substrate in a first linked chamber of the track lithography tool;
exposing a portion of the one or more coating layers using a scanner; and
processing the substrate in a non-horizontal orientation in a second linked chamber of the track lithography tool.

15. The method of claim 14 wherein the non-horizontal orientation is substantially vertical.

16. The method of claim 15 wherein substantially vertical comprises a plane parallel to the front surface of the wafer being aligned to within +/−5° of vertical.

17. The method of claim 14 wherein processing the substrate is performed after exposing at least a portion of the one or more coating layers.

18. A track lithography tool for processing a substrate, the track lithography tool comprising:
a first process chamber adapted to process the substrate in a substantially horizontal orientation;
a scanner interface adapted to transfer the substrate to and from a scanner;
a second process chamber linked to the scanner interface and adapted to process the substrate in a substantially vertical orientation; and
a robot linked to the second process chamber and adapted to modify the orientation of the substrate to the substantially vertical orientation.

19. The track lithography tool of claim 18 wherein the robot is adapted to handle wet substrates.

20. The track lithography tool of claim 18 wherein the second process chamber comprises an immersion post-exposure bake chamber.
